(19) United States
(12) Patent Application Publication
(10) Pub. No.: US 2005/0095456 A1
(43) Pub. Date: May 5, 2005

(54) Organic electroluminescence device and method of manufacture

(75) Inventor: Keizo Takeda, Yamato-shi (JP)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/953,105

(22) Filed: Sep. 29, 2004

(30) Foreign Application Priority Data
Oct. 1, 2003 (JP) 2003-343048

(51) Int. Cl. H05B 33/14

(52) U.S. Cl. 428/690; 428/917; 313/504; 427/66

(57) ABSTRACT

An organic electroluminescence device of the present invention comprises a light emitting layer held between electrodes, the light emitting layer containing at least a host material and a dye or pigment. The light emitting layer further comprises an additive exhibiting an absorption edge of which energy level is higher than that of an absorption edge of the dye or pigment, but the difference of the energy levels being less than 120 kJ/mol, having no lone pair, and including at least two aromatic rings. The additive of the present invention is selected from a group consisting of phenyl-substituted anthracenes, naphthyl-substituted anthracenes, naphthyl-substituted naphthalenes, pyrenes, and a naphthacene derivatives.

### FIELD OF THE INVENTION

The present invention relates to an organic electroluminescence device. Specifically, the present invention relates to an organic electroluminescence device with longer lifetime and improved display properties by improving organic electroluminescence lifetime and relates to a method of manufacturing the organic electroluminescence device.

### BACKGROUND OF THE INVENTION

An organic electroluminescence (EL) device is a self-emitting device with very fast response. Applying the organic EL device to a display device can be expected to provide a good flat display device with wide viewing angle. Therefore, the organic EL device has been studied to be applied to flat display devices which are to be replaced for liquid crystal displays.

On the contrary, it has been known that the organic EL device has various disadvantages, and various researches have been given thereto. Especially, researches have been carried out from the perspective of the device configuration in terms of device lifetime associated with the degradation of luminescence properties due to oxidation of materials or electrodes by oxygen, crystallization of materials, or the like as the aforementioned disadvantages. Furthermore, the device lifetime has been tried to be increased by mixing a dye with good luminous efficiency into a light emitting layer to increase the efficiency of luminescence and reduce the load on the device. The aforementioned dye is an organic material, and the chemical properties of the dye influence the lifetime of the organic EL device. Moreover, the device lifetime is reduced also by degradation of the dye itself.

In order to correct the aforementioned disadvantages, various research projects have been carried out. However, the various research projects have not been sufficient especially concerning increase in lifetime of the brightness property.

[Patent Document 1] Japanese Patent Laid-Open Publication No. Hei9-205237

[Patent Document 2] Japanese Patent Laid-Open Publication No. Hei8-319482

[Patent Document 3] Japanese Patent Laid-Open Publication No. 2001-76877

[Patent Document 4] Japanese Patent Laid-Open Publication No. 2001-357972

[Patent Document 5] Japanese Patent No. 2957793

[Patent Document 6] Japanese Patent No. 2552036

[Patent Document 7] Japanese Patent Laid-Open Publication No. 2000-164362

### SUMMARY OF THE INVENTION

It is an aspect of the present invention to provide a further extension of life of the dye for the organic EL device which is added in the light emitting layer and gives light emission with a desired wavelength. It is another aspect of the present invention to provide an organic EL device with longer luminescence life time by preventing dye degradation, and to provide a method of manufacturing such EL device.

The present invention focused attention on a close relationship between mechanisms of luminescence and dye degradation and examined the mechanism of dye degradation. Hence, it was found possible to effectively extend the lifetime of the dye by adding an additive whose energy level has a certain relationship with the energy level of the dye.

A particular aspect of the present invention provides an organic electroluminescence device including: a pair of electrodes and a light emitting layer interposed therebetween, the light emitting layer comprising a host material, a dye or pigment, and an additive. The additive exhibits an absorption edge of which energy level is higher than that of the dye or the pigment, having no lone pair in a main skeleton giving a highest occupied molecular orbital and a lowest unoccupied molecular orbital, and including at least two aromatic rings. Moreover, the mass ratio of the additive to the dye or pigment is more than 1:1. The additive is selected from a group consisting of phenyl-substituted anthracenes, naphthyl-substituted anthracenes, naphthyl-substituted naphthalenes, pyrenes, and naphthacene derivatives.

A further aspect of the present invention provides a method of manufacturing an organic electroluminescence device, comprising the steps of: giving a substrate; forming a first electrode on the substrate; forming at least a light emitting layer on the substrate; and forming a second electrode to form a current path between the first electrode and the second electrode. The step of forming the light emitting layer includes a step of depositing a host material, a dye, and an additive. The additive exhibits an absorption edge of which energy level is higher than that of an absorption edge of the dye or pigment, has no lone pair in a main skeleton giving a highest occupied molecular orbital and a lowest unoccupied molecular orbital, and includes at least two aromatic rings, and the mass ratio of the additive to the dye or pigment is more than 1:1.

### BRIEF DESCRIPTION OF THE DRAWINGS

For a more complete understanding of the present invention and the advantages thereof, reference is now made to the following description taken in conjunction with the accompanying drawings.

FIG. 1 is a schematic view showing a structure of an organic EL device of the present invention.

FIG. 2 is a schematic view showing a mechanism of the present invention.

FIG. 3 is a schematic view showing examples of the organic EL device of the present invention.

FIG. 4 is a graph plotting the brightness lifetime obtained in Examples 1 to 4 with respect to the DPA concentration.

### DETAILED DESCRIPTION OF THE INVENTION

The present invention provides a further extension of life of a dye for an organic EL device which is added in a light emitting layer and gives light emission with a desired wavelength. The present invention also provides an organic EL device with longer luminescence life time by preventing dye degradation, and provides a method of manufacturing such EL device.

The present invention focuses attention on a close relationship between mechanisms of luminescence and dye degradation and examined the mechanism of dye degradation. Hence, it was found possible to effectively extend the lifetime of the dye by adding an additive whose energy level has a certain relationship with the energy level of the dye. Specifically, the inventors focused attention on the followings: luminescence in the organic EL device is given by an excited state of the dye produced by recombination of holes and electrons; in a fluorescent dye, efficient luminescence is given by a singlet state of the dye; and, statistically, an excited triplet state giving no efficient luminescence is formed three times as much as the excited singlet state. Dye molecules are basically stable in the ground state thereof. However, in the excited states, the dye molecules are considered to be changing by various chemical reactions while staying in the excited states.

Therefore, it is preferable to reduce the period of time when the dye is in the excited states as much as possible.) However, reduction of the period of time when the dye is in the excited singlet state is not preferred because the luminous efficiency is reduced. The excited singlet state usually has a large transition moment to generate high efficient luminescence. Even if produced, the excited singlet state returns to the ground state with high efficiency. However, in the triplet state, optical transition to the ground state is forbidden under normal circumstances. Accordingly, once generated, the triplet state either returns to the ground state by intersystem crossing or triplet-to-triplet quenching or disappears by a chemical reaction, any of which are considered to play a considerable role in the dye degradation mechanism. As a result of diligent research, the inventors found that it was possible to extend the dye lifetime and the luminescence lifetime of the organic EL device by efficient quenching of the excited triplet state, which is unavoidably produced due to the luminescence mechanism in the organic EL device and usually produced more than the intended purpose of the dye, thus leading to the present invention.

Specifically, an embodiment of the present invention provides an organic electroluminescence device including a pair of electrodes and a light emitting layer interposed therebetween, the light emitting layer comprising a host material, a dye or pigment, and an additive. The additive exhibits an absorption edge of which energy level is higher than that of the dye or the pigment, having no lone pair in a main skeleton giving a highest occupied molecular orbital and a lowest unoccupied molecular orbital, and including at least two aromatic rings. Moreover, the mass ratio of the additive to the dye or pigment is more than 1:1. The additive is selected from a group consisting of phenyl-substituted anthracenes, naphthyl-substituted anthracenes, naphthyl-substituted naphthalenes, pyrenes, and naphthacene derivatives. Preferably, the additive is selected from a group consisting of 9,10-diphenylanthracene, 9,10-dinaphthylanthracene, naphthylnaphtharene, and rubrene. Furthermore, the light emitting layer includes an aluminum-quinolinol complex. Preferably, an energy level of the absorption edge of the dye is lower than that of the additive by at least 2.5 kJ/mol.

The present invention also provides an embodiment of a method of manufacturing an organic electroluminescence device, comprising the steps of: giving a substrate; forming a first electrode on the substrate; forming at least a light emitting layer on the substrate; and forming a second electrode to form a current path between the first electrode and the second electrode. The step of forming the light emitting layer includes a step of depositing a host material, a dye, and an additive. The additive exhibits an absorption edge of which energy level is higher than that of an absorption edge of the dye or pigment, has no lone pair in a main skeleton giving a highest occupied molecular orbital and a lowest unoccupied molecular orbital, and includes at least two aromatic rings, and the mass ratio of the additive to the dye or pigment is more than 1:1. The step of forming the light emitting layer can comprise a step of depositing an aluminum-quinolinol complex as the host material. The step of forming the light emitting layer can comprise a step of depositing an additive selected from a group consisting of phenyl-substituted anthracenes, naphthyl-substituted anthracenes, naphthyl-substituted naphthalenes, pyrenes, and the naphthacene derivatives. Preferably, in the present invention, the additive is selected from a group consisting of 9,10-diphenylanthracene, 9,10-dinaphthylanthracene, naphthylnaphthalene, and rubrene.

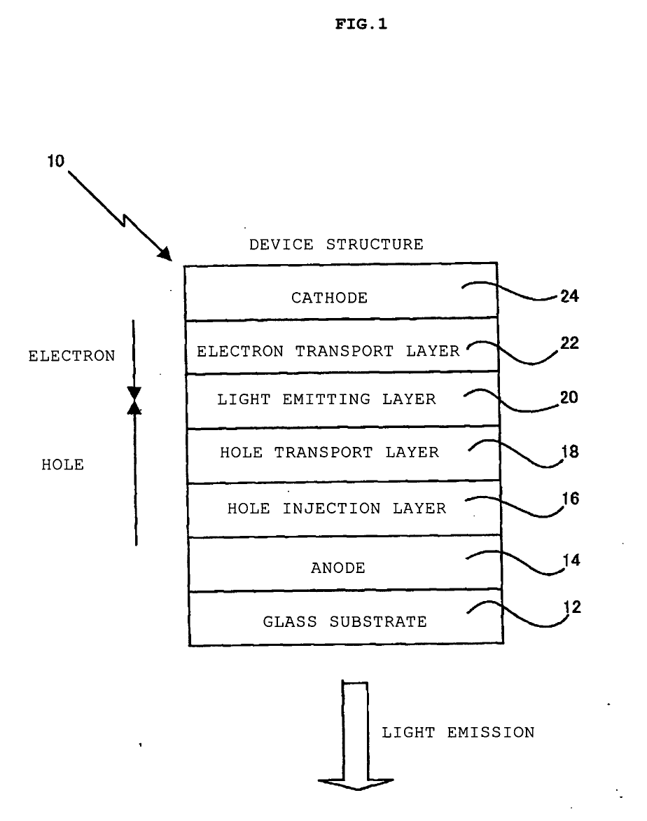

Hereinafter, though a description will be given of the present invention with an embodiment shown in the drawings, the present invention is not limited to the embodiment shown in the drawings. FIG. 1 schematically shows the configuration of an organic EL device of the present invention. As shown in FIG. 1, an organic EL device 10 of the present invention has a bottom emission structure, and an anode 14 is deposited on a substrate 12. Moreover, a hole injection layer 16 is deposited on the anode 14. In the case of adopting a bottom emission structure shown in FIG. 1, the substrate 12 can be composed of a transparent conductive material such as ITO using a proper deposition method such as sputtering. On the anode 14, the hole injection layer 16 is deposited by evaporation or the like. The hole injection layer 16 can be formed of a compound containing amine derivatives capable of generating holes, and specific examples which can be used therefor in the present invention include phtalocyanine and phthalocyanine complexes such as copper phthalocyanine.

On the hole injection layer 16, a hole transport layer 18 is formed using a deposition method such as evaporation. The hole transport material which can be used in the present invention can be any compound as long as the compound can move holes generated in the hole injection layer 16 to a light emitting layer described later. Specific examples thereof can include the following materials.

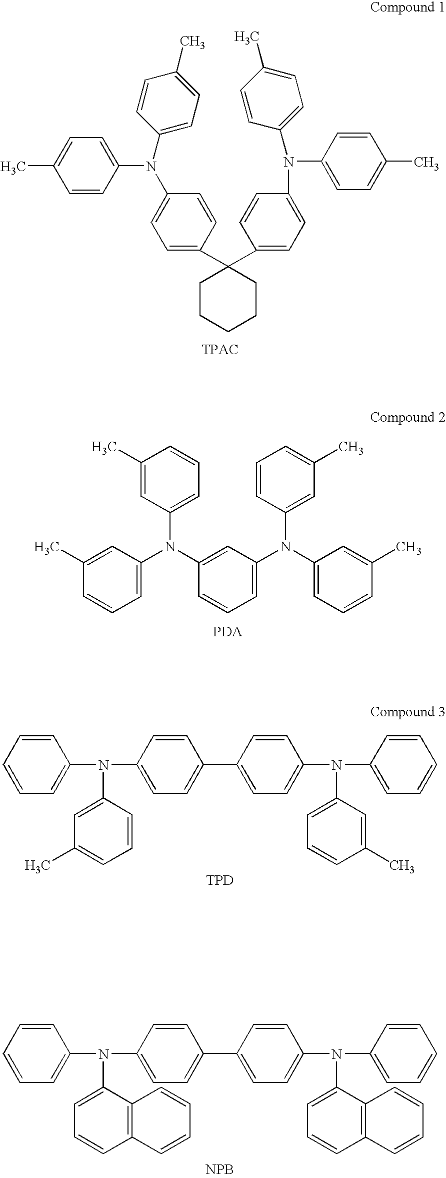

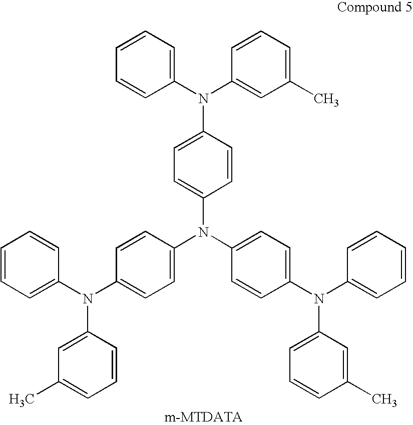

In addition to the aforementioned compounds, a polymeric hole transport material such as polyvinyl carbazole can be used in the present invention.

On the hole transport layer 18, a light emitting layer 20 is formed as shown in FIG. 1. The light emitting layer 20 is formed of a composition material which can provide luminescence by recombining holes and electrons. Specifically, the light emitting layer 20 of the present invention is formed including a host material, a dye capable of giving luminescence with a desired spectrum, and a triplet quencher as an additive which is used in the present invention. These materials are deposited on the hole transport layer 18 by a proper method such as evaporation.

The host material which can be used in the present invention is, for example, an aluminum-quinolinol complex such as Alq3 or also any known luminescent low or high molecular weight material. The following exemplifies luminescent materials which can be used in the present invention.

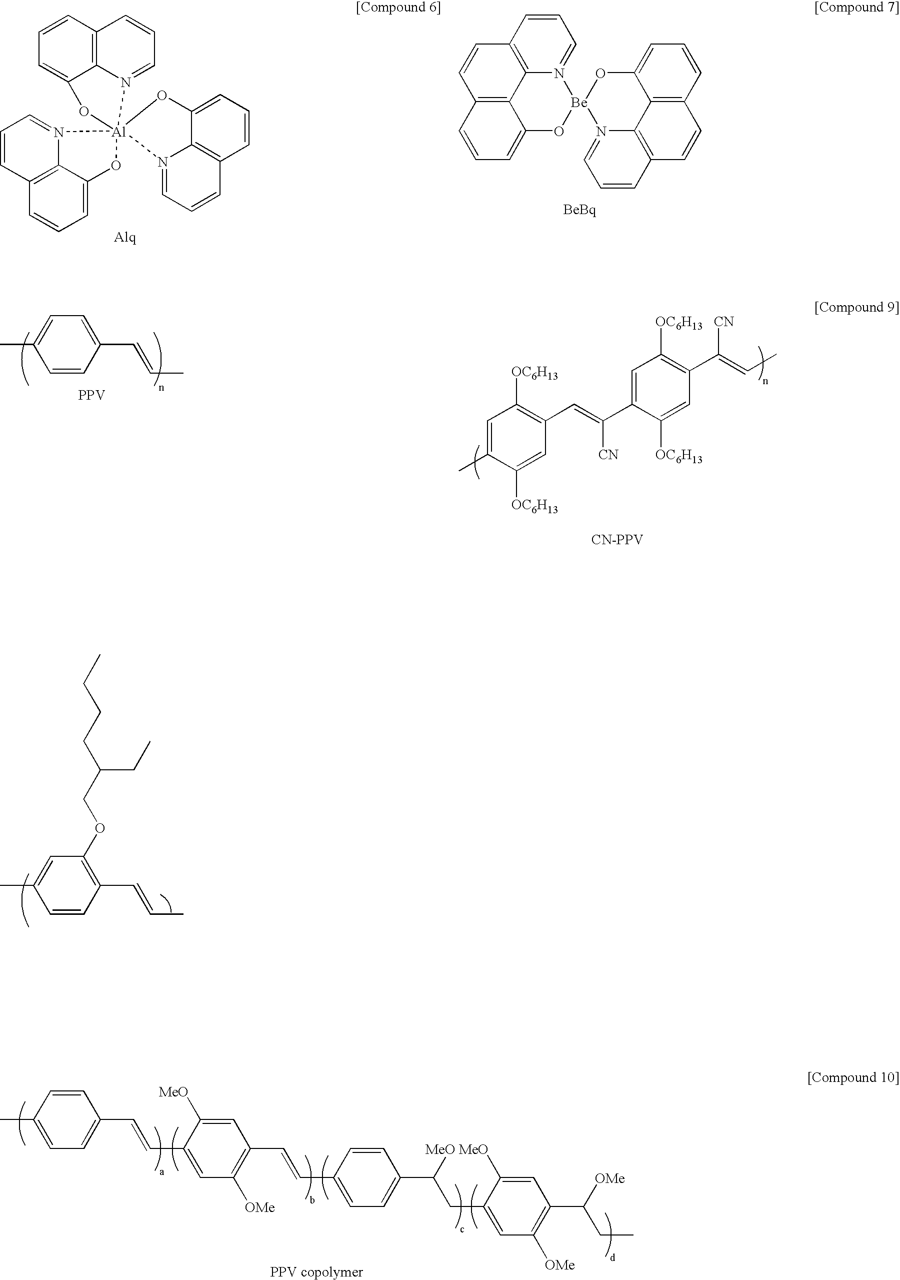

The aforementioned materials can be used singly or properly mixed when necessary. In the light of the luminescence property, film forming property, and productivity, use of Alq3 is preferred in the present invention.

In the organic EL device of the present invention shown in FIG. 1, an electron transport layer 22 is formed on the aforementioned light emitting layer 20. This electron transport layer 22 can be used for transporting electrons emitted by a cathode described later to the light emitting layer 20 to give electroluminescence. The aforementioned Alq3 can be also used as the electron transport material of the present invention. In addition to the electron transport material such as Alq3, materials exemplified in the following can be used for the electron transport layer in the present invention.

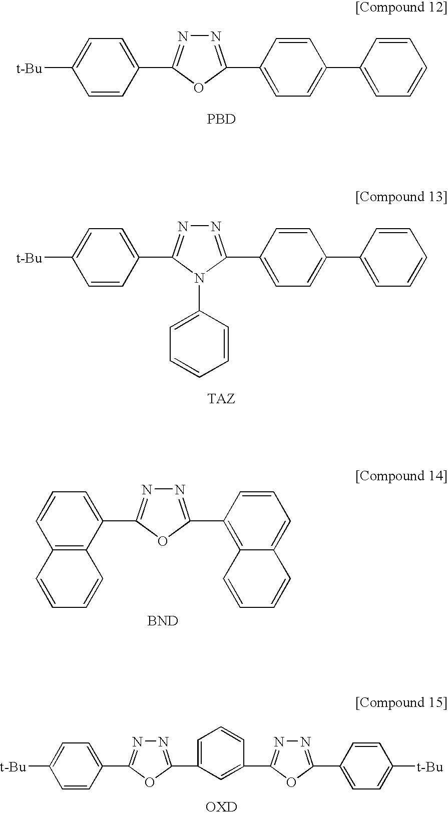

The organic EL device 10 shown in FIG. 1 further includes a cathode 24 deposited as a topmost layer, and the cathode 24 supplies electrons to cause luminescence. Since the embodiment of the present invention shown in FIG. 1 has a bottom emission structure, the cathode 24 is formed of a reflective material such as Al, Ag, Ni, Ni/Al, and MgAg to efficiently reflect light emitted from the light emitting layer 20. Furthermore, the organic EL device of the present invention may include a protection film formed therein to shield each member shown in FIG. 1 from water or oxygen in the environment.

In the embodiment shown in FIG. 1, the organic EL device of the bottom emission structure is described. However, the present invention can be applied to an organic EL device of top emission structure by forming the anode 14 of a reflective material and forming the cathode 24 of a transparent material.

In the present invention, it was found that the luminescence lifetime of the organic EL device was increased by forming the aforementioned light emitting layer 20 by using a host material, a dye, and an additive having a certain energy correlation with the dye.

For the dye in the present invention, any known dye can be used, for example, a dye for laser oscillation. Specific examples thereof can be p-terphenyl, QUI, polyphenyl 1, stilbene 1, stilbene 3, coumarin 2, coumarin 47, coumarin 102, coumarin 30, rhodamine 6G, rhodamine B, DCM, DCM2, DCJTB, rhodamine 700, styryl 9, HLTCL, and IR 140 (catalogue of laser dye molecules, Lamba Physics, Inc.), and coumarin C-545, coumarin C-545T, coumarin C-545B, 5,7-dimethoxycoumarin, a quinacridone dye such as N,N′-dimethylquinacridone, an anthraquinone dye such as N,N,N′,N′-tetraphenyl-9,10-diaminoacetone, and a porphyrin dye such as tetraphenylporphyrin, or pigment. In the present invention, any known material can be used for the dye as long as the material is a fluorescent dye or pigment of a structure specified by the Color Index.

The additive which can be used in the present invention is a compound known as a so-called triplet quencher. For the additive which can be used in the present invention, a electron conjugated molecule with high triplet quenching efficiency is preferable, and a compound which does not absorb fluorescence from the aforementioned dye is preferable. Furthermore, it is preferable that the aforementioned additive has an energy level of S₁ higher than that of the dye or pigment in terms of preventing quenching by energy transfer from the formed excited state S₁ of the dye or pigment. Specific examples of the additive which can be used for the aforementioned triplet quencher can include naphthalene, naphthalene derivatives, anthracene, anthracene derivatives, naphthacene, naphthacene derivatives, pyrene, pyrene derivatives, perylene, and naphthyl quenchers.

Furthermore, in the present invention, it was found necessary that a certain combination of the dye and the triplet quencher has a certain energy correlation in order to especially extend the luminescence lifetime of the organic EL device of the present invention. Specifically, in the present invention, it was found that the effect of increasing the lifetime of the organic EL device can be obtained in the case of using materials of a combination of a dye or a pigment and a triplet quencher in which:
the energy level of the lowest excited singlet state (S₁) of the dye or pigment is lower than that of the lowest excited singlet state (S₁^{q}) of the triplet quencher;
the dye or pigment includes a chromophore giving absorption by n-^{π}* transition; and
the triplet quencher has no lone pair and gives the state S₁^{q} by ^{π}-^{π}* transition.

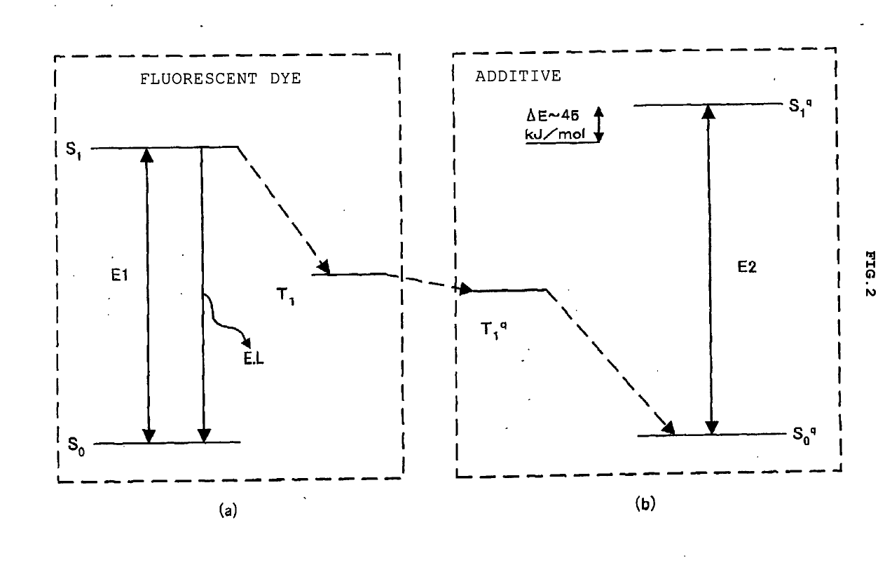

There can be various reasons why the aforementioned configuration in the present invention increases the luminescence lifetime of the organic EL device. FIG. 2 shows a mechanism of extending the luminescence lifetime of the present invention presumed from the energy correlation between the dye and the triplet quencher, and the luminescence lifetime, as a result of diligent research by the inventors.

FIGS. 2A and 2B show energy correlation between the dye and the triplet quencher constituting the light emitting layer 20. FIG. 2A shows the energy level of the fluorescent dye, and FIG. 2B shows the energy level of the triplet quencher. In the dye shown in FIG. 2A, the electronic ground state is referred as S₀, the lowest excited singlet state is referred as S₁, and the energy difference between S₀ and S₁ is referred as E1. FIG. 2A shows the presence of the triplet state T₁ between the S₀ and S₁ levels. In the organic EL device, recombination of holes and electrons results in the excited states S₁ and T₁ of the dye. In this case, the states S₁ and T₁ are produced in a ratio of 1:3 depending on the spin states of electrons giving the hole spin state and electrons supplied from the cathode. Moreover, the state S₁ once generated transits to the ground state while generating fluorescence and simultaneously relaxes to the state T₁ by intersystem crossing. The state T₁ produced by the aforementioned mechanism has an absorption band (triplet-triplet absorption) different from that of the ground state. A molecule in the ground state is less likely to absorb such fluorescence because of Stokes shift. However, the triplet-triplet absorption often takes place in the visible range, and a molecule in the state T₁ is likely to absorb fluorescence. In the case where a molecule in the state T₁ absorbs fluorescence, energy being high enough to cut the chemical bond is stored in the molecule. Accordingly, accumulation of molecules in the T₁ state level inversely affects the dye.

On the other hand, the triplet quencher also has levels of the ground state S₀^{q}, lowest excited singlet state S₁^{q}, and the triplet state T₁^{q}. The states S₀^{q} and S₁^{q} have an energy difference E2, and the state T₁^{q} is at the intermediate energy level. In order that the triplet quencher used in the present invention does not reabsorb light emitted by S₁-S₀ transition of the dye and the singlet-singlet energy transfer does not quench the produced state S₁, it is presumed that E2>E1, namely, S₁^{q}>S₁ is preferable in the present invention.

The state T₁ caused in the dye molecule is statistically produced three times as much as the state S₁ from the time of production. Accordingly, it is preferable to quickly release the energy as the excited triplet state in the dye molecule in order that the dye molecule itself does not undergo chemical change. This requires efficient quenching of the produced state T₁. Therefore, it is preferable to transfer energy from the produced state T₁. At this time, the level enabling efficient exchange of energy is considered to be the level of the state T₁^{q} of the triplet quencher in the light of spin conservation or the like. However, in the case where the energy level of the state T₁^{q} of the triplet quencher is higher than that of the state T₁, no efficient energy transfer is caused because of the law of energy conservation. Accordingly, the energy level of the state T₁^{q} is required to be lower than that of the state T₁.

Unfortunately, enough knowledge has not been obtained about the energy levels of the state T₁ of the dye and the state T₁^{q} of the triplet quencher. Consequently, there is not enough knowledge to select materials having the aforementioned relationship. Therefore, the inventors researched combinations of materials with the aforementioned features using photochemical and quantum-chemical knowledge and results of absorption spectrum in the form of thin films.

Generally, the lowest excited singlet state of an organic compound is ^{π}* in a ^{π} conjugated system. On the other hand, electrons transiting to the aforementioned ^{π}* level depends on the structure of the organic compound. In an organic compound having lone pairs, electrons of lone pairs transit, that is, so-called n-^{π}* transition is caused in many cases. In an organic compound including no lone pair, electrons of the ^{π} orbital giving the most stable energy level transit, and this electron transition is the so-called ^{π}-^{π}* transition. Furthermore, in many cases, the energy level of the lone pairs is considered to be higher than that of the bonding orbital ^{π} formed of electrons contributing bonding and lower than the antibonding orbital ^{π}*.

Therefore, in the present invention, the condition S₁^{q}>S₁ can be met by using dye with lone pairs and the triplet quencher with no lone pair. The amount of energy for stabilization from the energy of the orbital ^{π}* level to the energy of the triplet level corresponds to a value of exchange repulsion integrals Kia from a quantum-chemical viewpoint. Herein, i indicates the electron orbital in the ground state, and a indicates the electron orbital in the excited state. Furthermore, the value of Kia has a property to increase as spatial overlap of orbitals decreases and decrease as the spatial overlap of orbitals increases. The shape of a lone pair is substantially close to that of an atomic orbital of an atom having the lone pair. Accordingly, overlap of the lone pair and the antibonding orbital is considered to be smaller than overlap of the bonding and antibonding molecular orbitals.

From the above point of view, it is predicted that the state T₁ of the dye can be effectively quenched by using the dye including the lone pair and selecting a compound as the triplet quencher which includes no lone pair and has the state S₁^{q} with an energy level higher than that of the state S₁ by twice (2Kia) the value of the exchange integral.

Specifically, according to the present invention, increasing the luminescence lifetime of the organic EL device requires use of a combination of the dye and the triplet quencher in which the energy in the state S₁ of the dye and the energy in the state S₁^{q} of the triplet quencher are given by the following Equation 1.

[Equation 1]
S₁^{q}−S₁^{≦}|2Kia| (1)
In the above Equation 1, 2Kia is a value obtained by calculation. On the other hand, the 2Kia is considered as absorption corresponding to S₁^{←}S₀ transition of a thin film formed of the host material, the dye, and the triplet quencher. Accordingly, in the present invention, research was made on a combination of the dye and the triplet quencher used therefor by using the following Equation 2 which includes an energy difference between absorption edges of the respective compounds instead of the value of 2Kia. Herein, the above energy difference is considered to reflect the environment within the bulk on the energy difference between the lowest excited singlet states in the absorption spectrum of the thin film.

[Equation 2]
S₁^{q}−S₁˜^{Δλ}e (2)
In the above Equation (2), e represents the energy at the longer wavelength absorption edge of each of the dye and the triplet quencher. According to the above equation (2), it is required to use a combination of materials as follows:
the longer wavelength absorption edges thereof are as close to each other as possible;

the longer wavelength absorption edge of the triplet quencher has a value not more than a predetermined value and is on the shorter wavelength side of the absorption edge of the dye. Table 1 shows energy of the state S₁ (S₁^{q} for triplet quencher) estimated for each compound from literature.

TABLE 1

| Compound | S₁ energy (kJ/mol) |
|---|---|
| 5,7-dimethoxycoumarin | 339 |
| coumarin 6 | 260 |
| rhodamine 6G | 181 |
| tetraphenylporphyrin | 179 |
| naphthylnaphthalene | 359 |
| 9,10-diphenylanthracene | 304 |
| rubrene | 221 |

As a result of diligent research, the inventors found that the luminescence lifetime of the organic EL device could be effectively improved by using a combination of a dye having lone pairs and a triplet quencher having no lone pair which had a energy correlation in which the aforementioned ^{Δλ}e was not more than about 120 kJ/mol. Furthermore, in the present invention, energy transfer can be caused when the difference ^{Δλ}e is equal to at least a thermal distribution (kT=2.5 kJ/mol; k is the Boltzmann constant, and T is the absolute temperature) at room temperature. Therefore, it was found particularly preferable to use a dye and a triplet quencher of predetermined structures which had an energy correlation shown in the following Equation (3). Further research by the inventors revealed that it was possible to obtain a preferable result with an energy correlation in which the aforementioned ^{Δλ}e was not more than about 45 kJ/mol.

[Equation 3]
2.5 kJ/mol^{≦}S₁^{q}−S₁^{≦}120 kJ/mol (3)

In forming the light emitting layer 20 of the present invention, it is possible to use any known proper deposition method, for example, evaporation. The host material, dye, and triplet quencher can be simultaneously evaporated from different sources.

In the present invention, preferably, the content of dye in the light emitting layer 20 is 0.1 to 3 mass % of a composition forming the light emitting layer 20, and more preferably, 0.1 to 2 mass %. The content of triplet quencher in the light emitting layer 20 is more than that of dye or pigment in terms of mass, and preferably, can be 1 to 10 mass %. Furthermore, it was found that 4 to 5 mass % was more preferable in terms of crystal formation of the host material. In terms of the ratio of the triplet quencher to the dye or pigment, the triplet quencher and the dye or pigment can be added in a ratio of 0.5:1 to 100:1. Further diligent research by the inventors revealed that a ratio range of the triplet quencher to the dye or pigment of more than 1:1 but not more than 10:1 could be adopted as a preferable range for improving the luminescence lifetime in a actually meaningful range. When the above ratio is not more than 1:1, the improvement in increasing the luminescence lifetime is insufficient, and when the ratio is more than 10:1, there is a tendency that the luminous efficiency decreases.

### EXAMPLES

Hereinafter, the present invention will be described with specific examples. The present invention is not limited by examples described later. Table 2 shows compositions used in the examples.

### Examples 1 to 4

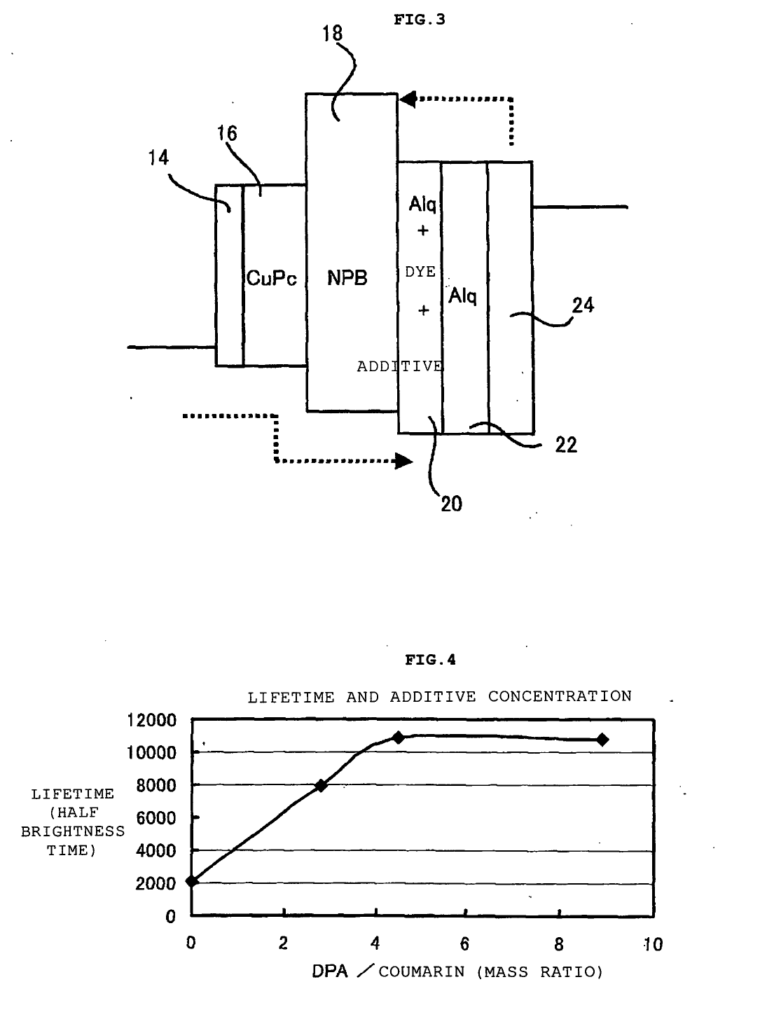

Organic EL devices were formed as shown in FIG. 3. Each organic EL device shown in FIG. 3 was produced in the following manner. First, copper phthalocyanine was evaporated as the hole injection layer to a thickness of 10 nm on a glass substrate with an ITO film deposited as the anode. ^{α}-NPB was then deposited thereon to form the hole transport layer with a thickness of 30 nm. On the formed hole transport layer, Alq3, 1 mass % of coumarin 6, and about 3, 5, or 9 mass % or none of 9,10-diphenylanthracene (DPA) to be the triplet quencher were evaporated from different sources and were deposited into the light emitting layer with a thickness of 30 nm. Subsequently, Alq3 was deposited thereon to form an electron injection layer with a thickness of 30 nm. After LiF was evaporated to about 0.5 nm, Al was evaporated to form the cathode with a thickness of 200 nm. Lead lines are attached to the anode and cathode of the produced organic EL device by using silver paste and connected to a constant voltage power. When current with 10 mA/cm² was supplied, good green emission was obtained.

(Luminescence Lifetime Measurement)

The organic EL devices obtained in the examples were subjected to an accelerated test of the degradation property of the luminescence lifetime. The measurement was carried out with a current density of 10 mA/cm².

The result thereof is shown in Table 3 and FIG. 4.

TABLE 3

| | | | | |
|---|---|---|---|---|
| DPA | 0 | 2.8 | 4.5 | 8.9 |
| Concentration/ | | | | |
| Coumarin | | | | |
| Concentration | | | | |
| Lifetime | 2,078 | 7,896 | 10,853 | 10,795 |
| (Half | | | | |
| Brightness | | | | |
| Time: hr) | | | | |

The lifetime ^{τ} of a coumarin triplet is expressed as follows. Herein, [DPA] is the concentration of DPA, kq is a quenching rate constant by DPA, and k0 is a decay rate constant of the coumarin triplet in the absence of DPA.
^{τ}=1/(k0+kq[DPA]) (4)

This reveals that higher DPA concentration reduces the lifetime of the coumarin triplet. Considering this in terms of the triplet-triplet absorption efficiency, the shorter lifetime of the coumarin triplet could lower the possibility that the triplet absorbs fluorescence. Accordingly, it is considered that higher DPA concentration leads the longer lifetime of the device. In the case of the examples, the lifetime increases as the DPA concentration increases to about 4% to 5%, but the effect thereof is saturated with a DPA concentration of more than about 5%. This is considered to mean that more triplets which are effectively present are deactivated as the DPA concentration increases.

### Examples 5 to 8

Similar experiment was carried out with the amounts of dye and additive changed as shown in Table 2, and good results were obtained.

As described above, according to the present invention, the luminescence lifetime of the organic EL device can be increased, and it is possible to provide an organic EL device with longer lifetime and good display properties.

TABLE 2

| | | S₁ | Added | | S₁ | Added |
|---|---|---|---|---|---|---|
| | | Energy | Amount | | Energy | Amount |
| Example | Dye | (kJ/mol) | (mass %) | Additive | (kJ/mol) | (mass %) |
| Example 1 | coumarin 6 | 260 | 1 | 9,10-diphenylanthracene | 304 | 0 |
| Example 2 | coumarin 6 | | 1 | 9,10-diphenylanthracene | | 3 |
| Example 3 | coumarin 6 | | 1 | 9,10-diphenylanthracene | | 5 |
| Example 4 | coumarin 6 | | 1 | 9,10-diphenylanthracene | | 9 |
| Example 5 | rhodamine | 181 | 1 | rubrene | 221 | 3 |
| | 6G | | | | | |
| Example 6 | rhodamine | | 1 | rubrene | | 5 |
| | 6G | | | | | |
| Example 7 | 5,7-dimethoxycoumarin | 339 | 1 | 2-naphthyl2′- | 359 | 1 |
| | | | | naphthalene | | |
| Example 8 | 5,7-dimethoxycoumarin | | 1 | 2-naphthyl2′- | | 2 |
| | | | | naphthalene | | |

Although the preferred embodiment of the present invention has been described in detail, it should be understood that various changes, substitutions and alternations can be made therein without departing from spirit and scope of the inventions as defined by the appended claims.

1. An organic electroluminescence device comprising:
a pair of electrodes; and
a light emitting layer interposed therebetween, which comprises
a host material,
a dye or pigment, and
an additive exhibiting an absorption edge of which energy level is higher than that of an absorption edge of the dye or the pigment, having no lone pair in a main skeleton giving a highest occupied molecular orbital and a lowest unoccupied molecular orbital, and including at least two aromatic rings,
wherein the mass ratio of the additive to the dye or pigment is more than 1:1.

2. The organic electroluminescence device according to claim 1, wherein the additive is selected from a group consisting of phenyl-substituted anthracenes, naphthyl-substituted anthracenes, naphthyl-substituted naphthalenes, pyrenes, and a naphthacene derivatives.

3. The organic electroluminescence device according to claim 2, wherein the additive is selected from a group consisting of 9,10-diphenylanthracene, 9,10-dinaphthylanthracene, naphthylnaphtharene, and rubrene.

4. The organic EL device according to claims 1, wherein the light emitting layer comprises an aluminum-quinolinol complex.

5. The organic electroluminescence device according to claim 1, wherein an energy level of the absorption edge of the dye is lower than that of the additive by at least 2.5 kJ/mol.

6. A method of manufacturing an organic electroluminescence device, comprising the steps of:
obtaining a substrate;
forming a first electrode on the substrate;
forming at least a light emitting layer on the substrate; and
forming a second electrode to form a current path between the first electrode and the second electrode, wherein
the step of forming the light emitting layer includes a step of depositing a host material, a dye, and an additive, and
the additive exhibits an absorption edge of which energy level is higher than that of an absorption edge of the dye or pigment, has no lone pair in a main skeleton giving a highest occupied molecular orbital and a lowest unoccupied molecular orbital, and includes at least two aromatic rings, and
the mass ratio of the additive to the dye is more than 1:1.

7. The method of manufacturing an organic electroluminescence device according to claim 6, wherein
the step of forming the light emitting layer includes a step of depositing an aluminum-quinolinol complex as the host material.

8. The method of manufacturing an organic electroluminescence device according to claim 6, wherein the step of forming the light emitting layer includes a step of depositing an additive selected from a group consisting of phenyl-substituted anthracenes, naphthyl-substituted anthracenes, naphthyl-substituted naphthalenes, pyrenes, and the naphthacene derivatives.

9. The method of manufacturing an organic electroluminescence device according to claim 8, wherein the additive is selected from a group consisting of 9,10-diphenylanthracene, 9,10-dinaphthylanthracene, naphthylnaphthalene, and rubrene.

10. An apparatus to manufacture an organic electroluminescence device, comprising the steps of:
means for giving a substrate;
means for forming a first electrode on the substrate;
means for forming at least a light emitting layer on the substrate; and
means for forming a second electrode to form a current path between the first electrode and the second electrode, wherein
the means for forming the light emitting layer includes means for depositing a host material, a dye, and an additive, wherein the additive exhibits an absorption edge of which energy level is higher than that of an absorption edge of the dye or pigment, has no lone pair in a main skeleton giving a highest occupied molecular orbital and a lowest unoccupied molecular orbital, and includes at least two aromatic rings, and wherein the mass ratio of the additive to the dye is more than 1:1.

11. The apparatus to manufacture an organic electroluminescence device according to claim 10, wherein
the means for forming the light emitting layer includes means for depositing an aluminum-quinolinol complex as the host material.

12. The apparatus to manufacture an organic electroluminescence device according to claim 10, wherein
the means for forming the light emitting layer includes means for depositing an additive selected from a group consisting of phenyl-substituted anthracenes, naphthyl-substituted anthracenes, naphthyl-substituted naphthalenes, pyrenes, and the naphthacene derivatives.

13. The apparatus to manufacture an organic electroluminescence device according to claim 12, wherein the additive is selected from a group consisting of 9,10-diphenylanthracene, 9,10-dinaphthylanthracene, naphthylnaphthalene, and rubrene.
